(19) United States
(12) Patent Application Publication
(10) Pub. No.: US 2026/0120494 A1
(43) Pub. Date: Apr. 30, 2026

(54) USER AUTHENTICATION USING A GRAPHICAL USER INTERFACE

(71) Applicant: International Business Machines Corporation, Armonk, NY (US)

(72) Inventors: Thomas James Waterton, Southhampton (GB); Mark Andrew Woolley, Eastleigh (GB); Simon Edward Burns, Eastleigh (GB); Joseph Peter Kent, Stockbridge (GB)

(21) Appl. No.: 18/979,792

(22) Filed: Dec. 13, 2024

(30) Foreign Application Priority Data
Oct. 24, 2024 (GB) 2415659.8

(51) Int. Cl. G06V 30/32; G06V 10/75; G06V 10/94; G06V 30/14; G06V 30/19

(52) U.S. Cl. CPC G06V 30/36; G06V 10/751; G06V 10/945; G06V 30/14; G06V 30/19013; G06V 2201/10

(57) ABSTRACT

A method, computer program product, and computer system carry out a process of user registration. The process of user registration comprises receiving a registering user input of a drawing process of a drawn image into a graphical user interface and monitoring the first drawing process to gather registration metadata relating to the drawn image. The process also comprises providing, by applying an artificial intelligence image analysis method, a description of the drawn image. Further, the process comprises securely storing the description and a set of the registration metadata for later authentication by comparison to a description of a later drawn image and metadata relating to the later drawn image.

### BACKGROUND

The present invention relates to user authentication, and more specifically, to user authentication using a graphical user interface.

Traditional methods of user authentication, for example for devices or accounts, tend to rely on alphanumeric passcodes with optional complexity rules or simple graphical methods such as drawing a recognized line across a 3×3 dot grid.

With quantum computing growing in capability and in broader availability, both alphanumeric password and current graphical methods for authentication will soon become too weak to be secure, as quantum computers will be able to crack them much more quickly than traditional computers.

### SUMMARY

According to an embodiment of the present invention, a computer-implemented method includes a process of user registration. The process of user registration comprises receiving a registering user input of a drawing process of a drawn image into a graphical user interface and monitoring the first drawing process to gather registration metadata relating to the drawn image. The process also comprises providing, by applying an artificial intelligence image analysis method, a description of the drawn image. Further, the process comprises securely storing the description and a set of the registration metadata for later authentication by comparison to a description of a later drawn image and metadata relating to the later drawn image. for user authentication using a graphical user interface comprises registering a user. Registering the user comprises receiving a registering user input of a drawing process of a drawn image into the graphical user interface. Registering the user further comprises monitoring the drawing process to gather a set of registration metadata relating to the drawn image. Registering the user further comprises applying an artificial intelligence image analysis method to provide a description of the drawn image and securely storing the description and at least some of the set of registration metadata for later authentication by comparing to a description and corresponding metadata of a later drawn image.

Further embodiments are directed to a system, which includes a memory and a processor communicatively coupled to the memory, wherein the processor is configured to perform the method. Additional embodiments are directed to a computer program product, which includes a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

Embodiments of the present invention will now be described, by way of example only, with reference to the accompanying drawings:

FIG. 1 is a flow diagram illustrating a method of registration, in accordance with some embodiments.

FIG. 2 is a flow diagram illustrating a method of authentication, in accordance with some embodiments.

FIGS. 3A to 3E are a series of schematic diagrams showing an example user interface with an example of a method of registration of an image, in accordance with some embodiments.

FIG. 4 is a block diagram illustrating a system, in accordance with some embodiments.

FIG. 5 is a block diagram illustrating a computing environment, in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for user authentication using a graphical user interface. The user authentication includes a first stage of registering a user and a second stage of authenticating a user. The user authentication is provided by a user drawing an image in a graphical user interface according to specified requirements.

The registration stage includes securely storing a description of the drawn image as obtained from an applied artificial intelligence image analysis method. The registration stage also securely stores at least some of a set of registration metadata obtained by monitoring the drawing process.

The authentication stage includes receiving a later user input of a drawing process of a drawn image into the graphical user interface and comparing the AI generated description and drawing process metadata to authenticate the user.

The combination of these different factors makes such an authentication method more difficult to crack using a brute force approach. This is significant because with the advance of quantum computers, today's commonly used authentication methods such as pin codes and text-based passwords are predicted to no longer be secure when quantum computers are more readily available to more people including to hackers and other bad actors.

The present invention seeks to provide one or more concepts for user registration and authentication. Such concepts are computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor.

A method and system are provided for prompting a user to draw something unique to them in order to provide user authentication. User authentication is defined broadly as any form of user recognition, including unlocking a device, authenticating a user of a device or of an account, etc. Embodiments of the disclosed method and system are particularly aimed at the users of touch-screen devices such as tablets and smart phones, although other user interfaces on which a user can draw may apply the described method.

In various embodiments, the disclosed authentication method is an improvement in the technical field of computer security generally and more particularly in the technical field of controlling access to a device or to an application or service.

Embodiments of the disclosed method are substantially more difficult to break compared to the conventional pin code or password methods. In various embodiments, the user not only needs to supply a similar drawing, but also needs to substantially match metadata about what and how the image is drawn. The metadata may include factors such as: image item category (e.g. cat, car, or face, etc.); how that item is drawn (e.g. the starting point; direction from starting point; how many times the user takes their finger off the touchscreen; etc.); location of the image within the overall canvas grid (e.g. image to be drawn within the bottom-right quadrant, etc.); pen color chosen, etc.).

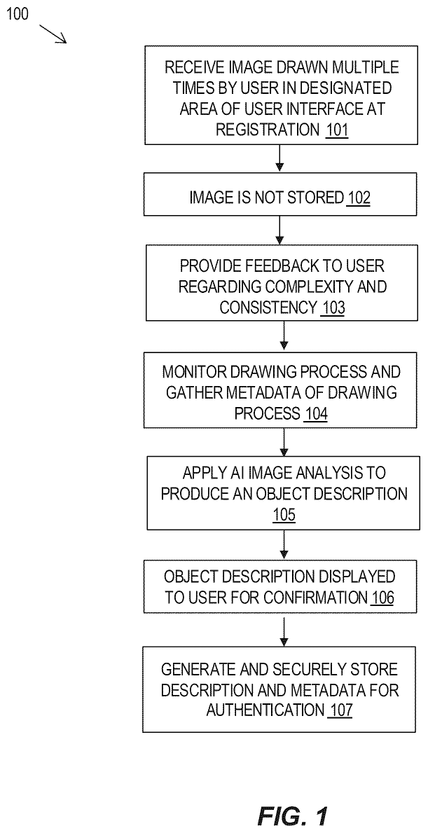

Referring to FIG. 1, a flow diagram shows a process 100 of user registration, according to some embodiments.

The method receives 101 a registering user input of a drawing process of a drawn image into the graphical user interface. The method may provide a grid structure in the user interface for the drawing process, which can include selectable drawing input characteristics. The method may provide a set of preset requirements for the drawing process.

Receiving 101 a registering user input of a drawing process includes receiving a repeated input of the drawing process for confirmation. The user input may be drawn multiple times by the user in a designated area of the user interface. The image is not stored 102 during the registration process. The method may provide feedback and requirements 103 to the user regarding the complexity and consistency of the drawing process and the drawn image.

The method monitors 104 the drawing process to gather a set of registration metadata relating to how the image is drawn. The monitoring 104 of the drawing process to gather a set of metadata includes monitoring selected input parameters (such as color, style, or line thickness) for the drawing process and/or monitoring drawing input characteristics. The input characteristics may include one or more of the group of: a start area in the user interface, an end area in the user interface, a direction of movement of a portion of the drawing input, a number of unique strokes used in the drawing input, a speed of input, etc.

The method applies 105 an artificial intelligence image analysis method to provide a description of the item or object of the drawn image. The description may be displayed 106 to the user for confirmation.

In an example embodiment, applying 105 an artificial intelligence image analysis method to provide a description of the drawn image includes providing one or more high-level text descriptions and providing words of the high-level text descriptions separately and with synonyms such that matching any word or synonym is accepted as valid, e.g., when authenticating a user.

The method may securely store 107 the description and at least some of the registration metadata for later authentication of the user by comparison to a description and metadata of a later drawn image.

The item description and at least some of the set of registration metadata in the form of the drawing process characteristics may be hashed in order to store a protected and unintelligible derivative of the description and metadata. A same hashing process may be used for an obtained description and metadata at a later authentication for comparison and verification. Storing the description as a hash may generate a hash as a random or unpredictable string of characters by an irreversible hash function. Hashes generated during registration and authentication are compared to determine if the description of the drawn image is the same.

As an alternative implementation to securely storing the description and metadata by hashing, the secure storing may use encryption. In such an implementation, the item description and at least some of the set of registration metadata in the form of the drawing process characteristics may be encrypted in order to store a protected and unintelligible derivative of the description and metadata. The description and registration metadata may be decrypted to be compared to an obtained description and metadata at a later authentication for comparison and verification.

The fact that the drawn image itself is not saved is a significant security enhancement as it means that even if the authentication provider's infrastructure was hacked, bad actors cannot discover the end user's authentication image itself. All that is stored is a hash or encryption of the metadata, which would not be of any use to the bad actors.

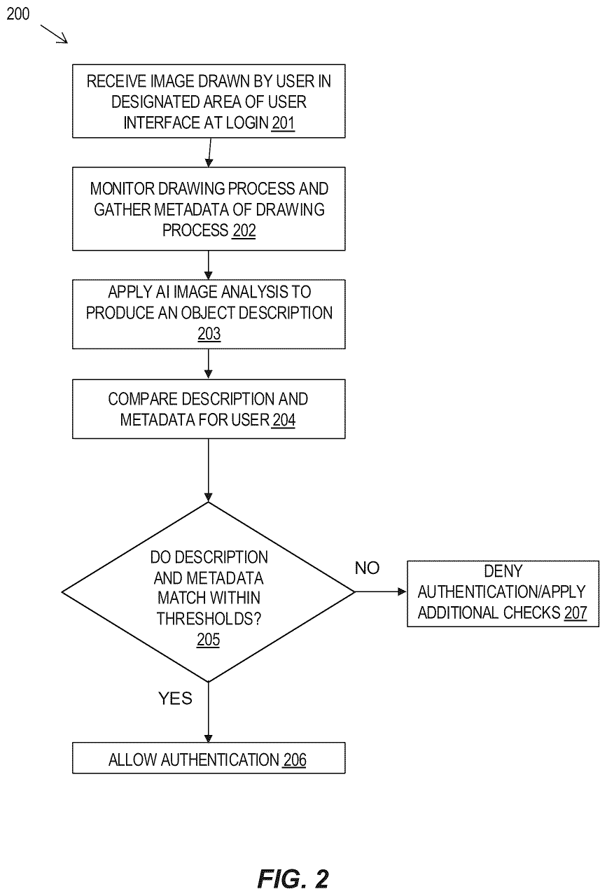

FIG. 2 is a flow diagram illustrating a method 200 of using a graphical user interface for authenticating a user, according to some embodiments.

The method receives 201 a user input of a drawing process of a drawn image into the graphical user interface at an authentication procedure. The drawing process and drawn image of method 200 are also referred to herein as a “later drawing process” and “later drawn image,” respectively. The method monitors 202 the drawing process to gather a set of metadata relating to the drawn image.

The method applies 203 an artificial intelligence image analysis method to provide a description of the item of the drawn image. Applying 203 an artificial intelligence image analysis method to provide a description of the drawn image includes applying a same method of artificial intelligence image analysis as the registration method. The applying 203 an artificial intelligence method may include applying any later artificial intelligence method and updating the securely stored data in the form of hashes or encryption the description and metadata to migrate to the later artificial intelligence method.

The method compares 204 the object (or item) description and metadata for the drawing process of the user. The method authenticates the user input by determining 205 if the newly generated description and at least some of the set of metadata of the monitored drawing process match the securely stored registration object description and metadata.

In the case where the securely stored registration object description and metadata are hashed, the newly generated description and metadata are hashed and compared. In another implementation using encryption, the securely stored registration object description and metadata may be decrypted and compared to the newly generated description and metadata. The comparing may determine 205 if the item description and metadata match within predefined thresholds such as a threshold confidence or threshold allowance.

When the item description and metadata match within the thresholds, the user authentication is allowed 206. When the item description and/or metadata do not match within the thresholds, the user authentication is denied, or additional checks are carried out 207, e.g., based on drawing characteristics. For some of the authentication comparing aspects (such as pen color chosen), the authentication check would be binary as either it matches or not.

For the authentication aspects involving the location of the drawing within the overall canvas, the precise coordinates may be identified, but a suitable offset may be applied (e.g. a tolerance of up to 30 pixels might be set) and the range may be stored as the metadata. For example, the range may be defined as a square of a grid of the user interface.

For other aspects (such as the artificial intelligence text description), a confidence score may be generated, and a confidence threshold may be set to be valid (e.g. the match has to meet or exceed a confidence score of 80%).

The confidence threshold may be used as part of the processes involved in methods 100 and 200. Both when initially creating a pass-image and in subsequent authentication attempts, the method may determine a confidence score (e.g. for the AI image analysis label). For example, it may only accept the AI image label as “cat” if the image label has a confidence rating of 80% or more. As an example, if the AI image analysis confidence threshold was set to 80% and in the original set-up drawing process, the identification of the object the user draws, has a confidence level of 84%, then it would be accepted. The image label (e.g. “cat”) would then get included in the securely stored description.

Then when the user later tries to authenticate, the method may run the image analysis on the input image, to identify the object that has been drawn, and to calculate a confidence level in that identification (e.g. “cat”). If the confidence level is below the threshold, the user would be asked to re-draw the picture. In this case they would not pass authentication.

For the authentication process to pass when using hashes, the overall hash may need to match the original. For example, if “cat” is included in the original hash, the user would only be authenticated if their subsequent image was also identified as being a “cat,” resulting in the hashes matching.

The following is an example of what the hash may be made up of, where all component parts would be included in the same set order. Other embodiments may use a different selection of metadata and may include more than one image description word.
<pen-color> (e.g. “red”)
<line-thickness-used> (e.g. “2”)
<number-of-unique-strokes>(e.g. “4”)
<grid-portions-used> (e.g. an array such as “A1:0, A2:1, A3:1, B1:0, B2:1, B3:1, C1:0, C2:0, C3:0”)
<grid-started-in> (e.g. “A2”)
<grid-finished-in> (e.g. “B3”)
<image-description> (e.g. “cat”).

The method has the advantages that it is easier for a user to remember their own picture is (e.g. a car or a cat, etc.) compared to trying to remember a 15-character text password, for example. The method is also easier for children and others who might have limited character recognition and/or typing abilities. Current text-based passwords can be especially difficult in this regard, as they often require the user to regularly switch functions from lowercase letters to uppercase letters to numbers to special characters, etc.

Artificial intelligence (AI) image recognition technology is used to identify what the picture is of (e.g. a car, a cat, a cloud, a house, etc.), and the description is securely stored as a hash or in an encrypted form.

Metadata may also be captured relating to other aspects of the user's picture, such as the color pen used, the grid coordinates where the drawing started/finished, the size of the picture relative to the canvas, etc. The metadata may also be hashed or encrypted and the result stored.

During the initial set-up and registration phase, the user may be required to draw their picture multiple times in order to validate that they can draw the same thing reliably and repeatedly and that the system is able to recognize it as being the same. As the user draws their unique picture, they may be given feedback to let them know if their drawing was of sufficient complexity to be secure. The user may also be shown the AI description of the drawing so they can confirm the system has correctly recognized what they have drawn.

Note that as an extra security precaution, the system does not store the original drawing, only securely stored information of the object recognized in the drawing and its associated metadata. So, even if a bad actor ever managed to access the database where users' picture information was stored, they would not know what the picture of a given user actually was.

After the user has completed the initial set-up and registration, whenever they authenticate themselves on their device, they are required to re-draw their picture such that AI analysis of the drawing produces the same description (e.g. a car, a cat, a house, etc.).

In addition, the drawing process is matched using the metadata. Examples of the drawing metadata may include the following:
a same color pen is used as in the original drawing;
a drawing starts and ends in the same areas of the grid as the original drawing;
a direction of movement matches that of the original drawing (e.g. if a circle is part of the picture, if the user started drawing from the top of the circle and moved clockwise in the original drawing, their subsequent drawings would need to match this direction);
an area on the screen the user draws in (e.g. in the center of a 3×3 grid, within the lower-left square, etc.);
what part of the shape the user starts drawing first (e.g. for a face, does the user start at the top of the head, bottom of the head, the eyes, or the mouth, etc.);
a number of unique strokes (i.e. interactions with the touchscreen) match the original drawing. For example, if the user drew an original smiley face in 5 separate drawing movements (between which they momentarily took their finger off the touchscreen) then their subsequent authentication attempts would also need to match this pattern.

Just as people develop “muscle memory” for writing their signature or playing a phrase on a musical instrument, if users adopt this authentication method and draw their pass-picture each day when using their touch-screen devices, they will develop “muscle memory” for repeating their unique pass-picture.

The AI image analysis aspect of the registration and authentication stages may use one of the many existing image analysis AI services and may be trained on a corpus of simple, hand-drawn pictures of everyday objects.

Where the method stores a hash of the picture description, not the description itself, the AI may be configured to generate only a basic, high-level text summary description for each picture (e.g. “tree”) rather than a more detailed description (e.g. “tree with round canopy, several branches, and fruit”) to avoid minor discrepancies in the drawing instances changing the overall summary description.

Where a text summary description does contain more than one word (e.g. “hand waving”) then each word may be hashed separately, and the order of the elements would not be important (meaning that an AI description of “hand waving”or “waving hand”would both be valid).

Similarly, common synonyms would be stored as part of this AI analysis process. Therefore, a description such as “smiley face” would not just have the words “smiley” and “face” but potentially other closely related words such as “smile”, “smiling”, “happy”, etc.

If the AI model came up with more than one possible image description that exceeded the set confidence score threshold (e.g. if the confidence threshold was set to 75%, and it generated “smiley face (82%)” and “winking face (78%)”) then both (or all) such text descriptions would be hashed and stored as valid.

AI models develop over time. To account for this, the authentication stage may analyze a user's drawing using both the same AI model that was used to save the image process originally and, optionally, one or more later AI models. For example, the same AI model used for registration may be used to validate the authentication request. Then, over multiple logins, the method may record and then start using the descriptions created by the newer AI model so that users benefit from using the more recent/advanced AI models over time.

Just like with other forms of password and pin codes, the user may be periodically required to update their pass-picture.

The following is an example implementation of the described initial registration process of creating a pass-picture. The user is provided with a graphical user interface with blank canvas area to draw on. The canvas may be split into a grid structure (e.g. a 3×3 grid, a 4×4 grid, etc.).

The user interface may provide a selection of drawing characteristics, such as colors and thicknesses or styles of line. There may be requirements set for the picture and for the method of drawing it. For example, the requirements may include how many times the user moves their finger/stylus off the touch-screen surface.

The user can draw a simple diagram of something that they will remember. The first time the user draws their diagram, they can repeat it multiple times to ensure consistency and repeatability of the image.

The AI image recognition tool may be run on the picture, and if it can determine what the picture is of, it may show this label to the user (e.g. “cat” or “car” or “house” etc.). If the AI tool is unable to determine what the image represents, it may ask the user to re-draw the picture until the AI tool recognizes the image. Thereafter, whenever the user is attempting to authenticate, the user can select their pen color, thickness, and style and then re-draw their picture.

To reduce the ability of someone looking over the user's shoulder while they draw their pass-picture, the method and system may be configured so that the ink could fade away as the user draws.

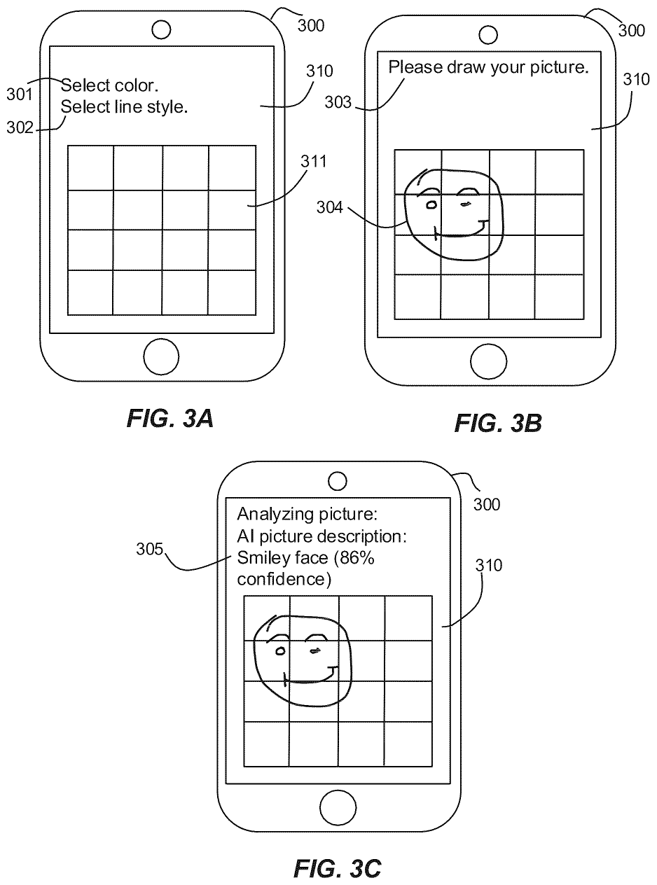

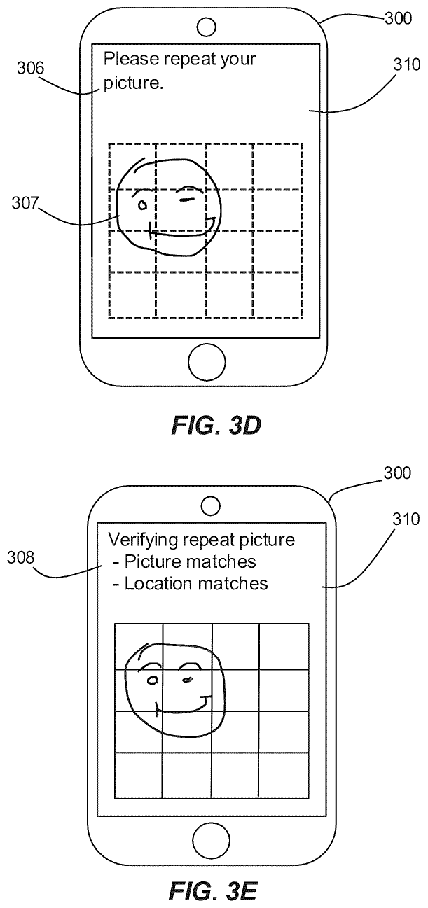

FIG. 3A-3E are schematic diagrams showing a graphical user interface 310 of a user device 300 that is configured to receive a user's drawing of an item for authentication, according to some embodiments. These figures show the initial set-up of a new pass-picture. FIG. 3A shows an instruction to select a color 301 and to select a line style 302 and shows an empty grid 311 of the graphical user interface 310. FIG. 3B shows an instruction 303 to draw a picture and shows a picture 304 as drawn in the grid 311. FIG. 3C shows an analyzing stage that produces the description “smiley face” 305 with an 86% confidence. FIG. 3D shows an instruction 306 to repeat the picture and a repeated picture 307 drawn in the grid 311. FIG. 3E shows a verification 308 of the repeated picture to check that the picture matches and the location in the grid matches.

The described method can be harder to break compared to conventional pass codes due to the plurality of data points that are used to create the user's unique sequenced pass-picture. The method can ask the user to supply their own unique pass-picture, which itself is not stored, but from which a complex, sequenced input is generated based on a variety of data points about the user's pass-picture and how it is drawn.

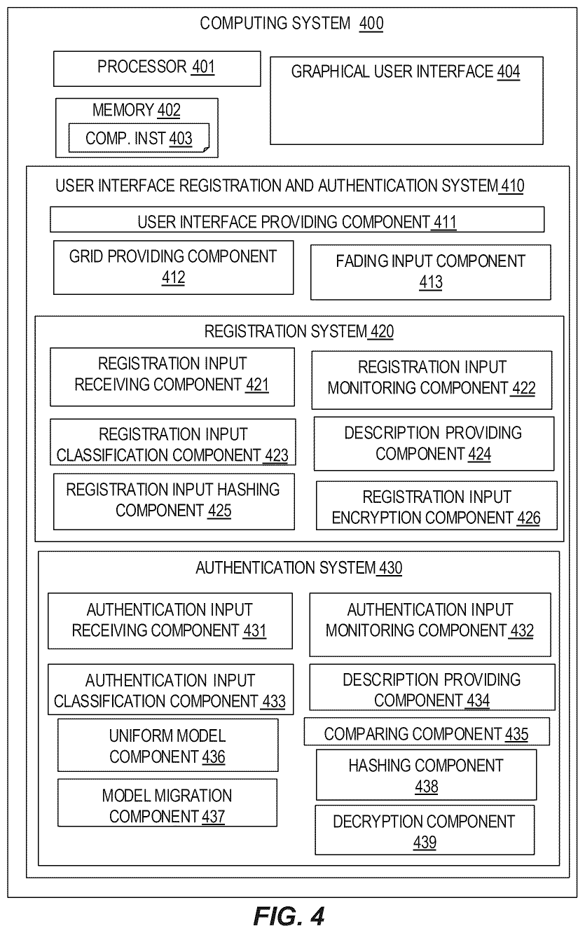

Referring to FIG. 4, a block diagram illustrates a computing system 400 in which the described system may be implemented, according to some embodiments. The computing system 400 may include at least one processor 401, a hardware module, or a circuit for executing the functions of the described components which may be software units executing on the at least one processor. Memory 402 may be configured to provide computer instructions 403 to the at least one processor 401 to carry out the functionality of the components.

The computing system 400 includes a graphical user interface 404 suitable for receiving a user input of a drawn image. The computing system 400 includes a user interface registration and authentication system 410 that applies the methods and components described herein.

The user interface registration and authentication system 410 includes a registration system 420 and an authentication system 430. The user interface registration and authentication system 410 includes a user interface providing component 411 including a grid providing component 412 for providing a grid structure in the user interface for the drawing process including selectable drawing input characteristics. The user interface providing component 411 may include a fading input component 413 for providing a fading display of a drawing line that is configured to fade in a defined time period.

The registration system 420 includes a registration input receiving component 421 for receiving a registering user input of a drawing process of a drawn image into the graphical user interface 404. The registration input receiving component 421 for receiving a registering user input of a drawing process includes receiving a repeated input of the drawing process for confirmation.

The registration system 420 includes a registration input monitoring component 422 for monitoring the drawing process to gather a set of registration metadata relating to the drawn image. The registration input monitoring component 422 includes monitoring selected input parameters for the drawing process; and/or monitoring drawing input characteristics.

The registration system 420 includes a registration input classification component 423 for applying an artificial intelligence image analysis method to provide a description of the drawn image. The artificial intelligence method may be an external model used by the described system. The registration system 420 includes a description providing component 424 for providing one or more high-level text descriptions and providing words of the high-level text descriptions separately and with synonyms such that matching any word or synonym is accepted as valid.

The registration system 420 includes a registration input hashing component 425 for generating and storing in a storage medium one or more hashes of the description and at least some of the set of registration metadata for authentication. Alternatively, the registration system 420 includes a registration input encryption component 426 for generating and storing, in a storage medium, encryptions of the description and at least some of the set of registration metadata for authentication.

The authentication system 430 includes an authentication input receiving component 431 for receiving a user input of a drawing process of a drawn image into the graphical user interface. The authentication system 430 includes an authentication input monitoring component 432 for monitoring the drawing process to gather a set of metadata relating to the drawn image.

The authentication system 430 includes an authentication input classification component 433 for applying an artificial intelligence image analysis method to provide a description of the drawn image. The artificial intelligence image analysis method may be carried out by a remote image analysis system.

The authentication input classification component 433 includes a uniform model component 436 for applying a same method of artificial intelligence image analysis as the registration method. The authentication input classification component 433 includes a model migration component 437 for applying any later artificial intelligence method and updating the securely stored data to migrate to the later artificial intelligence method.

The authentication system 430 includes a description providing component 434 for providing one or more high-level text descriptions and providing words of the high-level text descriptions separately and with synonyms.

The authentication system 430 includes a comparing component 435 for authenticating the user input by comparing the description and at least some of the set of metadata to the securely stored description and the corresponding registration metadata. The comparing component 435 may include a hashing component 438 for hashing the authentication input for comparing to the registered input hashes. Alternatively, the comparing component 435 may include a decrypting component 439 for decrypting stored registration input descriptions and metadata for comparison to the authentication input description and metadata.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

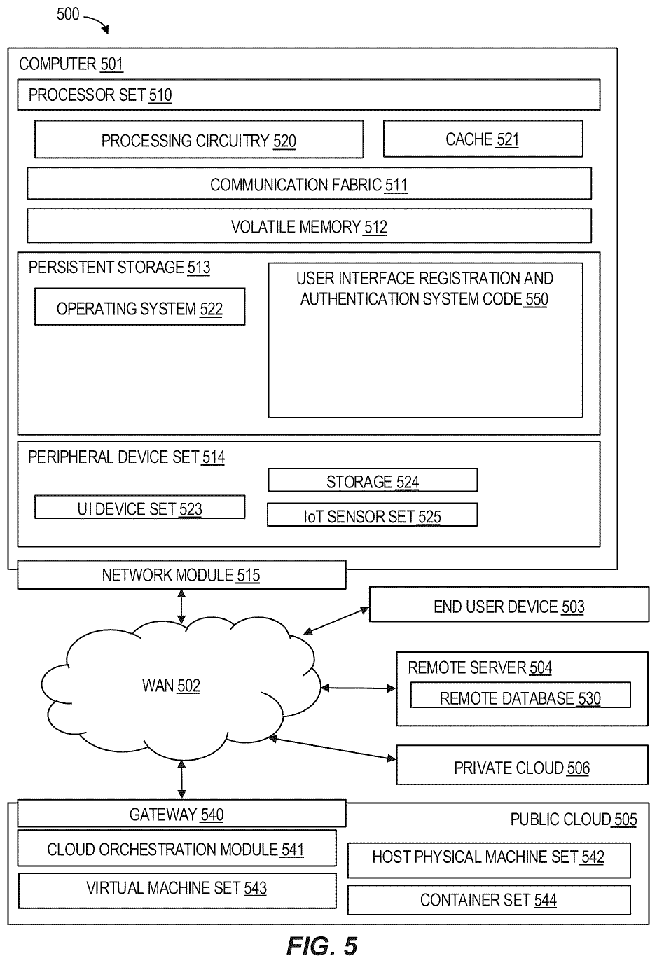

Referring to FIG. 5, computing environment 500 contains an example of an environment for the execution of at least some of the computer code involved in performing the inventive methods, such as user interface registration and authentication system code 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A method, comprising:
a process of user registration, the process of user registration comprising:
receiving a registering user input of a first drawing process of a drawn image into a graphical user interface;
monitoring the first drawing process to gather registration metadata relating to the drawn image;
providing a description of the drawn image, the providing the description of the drawn image comprising applying a first artificial intelligence image analysis method; and
securely storing the description and a set of the registration metadata for later authentication by comparison to a description of a later drawn image and metadata relating to the later drawn image.

2. The method of claim 1, further comprising a process of user authentication, comprising:
receiving a user input of a later drawing process of the later drawn image into the graphical user interface;
monitoring the later drawing process to gather the metadata relating to the later drawn image;
providing the description of the later drawn image, the providing the description of the later drawn image comprising applying the first artificial intelligence image analysis method; and
authenticating the user input by comparing the description of the later drawn image and a set of the metadata relating to the later drawn image to the securely stored description and set of the registration metadata.

3. The method of claim 2, the providing the description of the later drawn image further comprising:
applying a second artificial intelligence method and updating the securely stored description and set of registration metadata to migrate to the second artificial intelligence method.

4. The method of claim 2, wherein the authenticating the user input comprises comparing a confidence of the description of the later drawn image with a threshold confidence.

5. The method of claim 1, wherein the securely storing comprises generating hashes of the description of the drawn image and the registration metadata.

6. The method of claim 1, wherein the receiving the registering user input of the first drawing process comprises receiving a repeated input of the drawn image for confirmation.

7. The method of claim 1, wherein the providing the description of the drawn image comprises:
providing one or more high-level text descriptions; and
providing words of the one or more high-level text descriptions separately and with synonyms such that matching any word or synonym of the description of the later drawn image is accepted as valid.

8. The method of claim 1, wherein the monitoring the first drawing process comprises monitoring selected input parameters for the first drawing process, drawing input characteristics, or a combination thereof.

9. The method of claim 8, wherein the drawing input characteristics are selected from the group consisting of a start area in the graphical user interface, an end area in the graphical user interface, a direction of movement of a portion of the drawing input, and a number of strokes used in the drawing input.

10. The method of claim 1, further comprising providing a grid structure in the graphical user interface for the first drawing process, the grid structure comprising selectable drawing input characteristics.

11. The method of claim 1, further comprising providing a set of preset requirements for the first drawing process.

12. A computer system, comprising:
a processor set;
one or more computer-readable storage media; and
program instructions stored on the one or more computer-readable storage media to cause the processor set to perform operations comprising:
a process of user registration, the process of user registration comprising:
receiving a registering user input of a first drawing process of a drawn image into a graphical user interface;
monitoring the first drawing process to gather registration metadata relating to the drawn image;
providing a description of the drawn image, the providing the description of the drawn image comprising applying a first artificial intelligence image analysis method; and
securely storing the description and a set of the registration metadata for later authentication by comparison to a description of a later drawn image and metadata relating to the later drawn image.

13. The computer system of claim 12, wherein the operations further comprise a process of user authentication, comprising:
receiving a user input of a later drawing process of the later drawn image into the graphical user interface;
monitoring the later drawing process to gather the metadata relating to the later drawn image;
providing the description of the later drawn image, the providing the description of the later drawn image comprising applying the first artificial intelligence image analysis method; and
authenticating the user input by comparing the description of the later drawn image and a set of the metadata relating to the later drawn image to the securely stored description and set of the registration metadata.

14. The computer system of claim 13, the providing the description of the later drawn image further comprising:
applying a second artificial intelligence method and updating the securely stored description and set of registration metadata to migrate to the second artificial intelligence method.

15. The computer system of claim 13, wherein the monitoring the first drawing process comprises monitoring selected input parameters for the first drawing process, drawing input characteristics, or a combination thereof.

16. The computer system of claim 12, wherein the receiving the registering user input of the first drawing process comprises receiving a repeated input of the drawn image for confirmation.

17. The computer system of claim 12, wherein the providing the description of the drawn image comprises:
providing one or more high-level text descriptions; and
providing words of the one or more high-level text descriptions separately and with synonyms such that matching any word or synonym of the description of the later drawn image is accepted as valid.

18. The computer system of claim 12, wherein the operations further comprise providing a grid structure in the graphical user interface for the first drawing process including selectable drawing input characteristics.

19. The computer system of claim 12, wherein the system further comprises a fading display of a drawing line that is configured to fade in a defined time period.

20. A computer program product comprising:
one or more computer-readable storage media; and
program instructions stored on the one or more computer-readable storage media to perform operations comprising:
a process of user registration, the process of user registration comprising:
receiving a registering user input of a first drawing process of a drawn image into a graphical user interface;
monitoring the first drawing process to gather registration metadata relating to the drawn image;
providing a description of the drawn image, the providing the description of the drawn image comprising applying a first artificial intelligence image analysis method; and
securely storing the description and a set of the registration metadata for later authentication by comparison to a description of a later drawn image and metadata relating to the later drawn image.
